(19) United States
(12) Patent Application Publication
(10) Pub. No.: US 2013/0000813 A1
(43) Pub. Date: Jan. 3, 2013

(54) METHOD FOR PRODUCING AN ACOUSTIC AND THERMAL INSULATION MATERIAL

(76) Inventor: Oleg MUZYRYA, Lausanne (CH)

(21) Appl. No.: 13/480,978

(22) Filed: May 25, 2012

(30) Foreign Application Priority Data
Jun. 28, 2011 (FR) 1155756

(51) Int. Cl. B27N 3/18; B29C 65/02

(52) U.S. Cl. 156/62.4; 156/499

(57) ABSTRACT

Method for producing an acoustic and thermal insulation material and installation for implementing the method.

### BACKGROUND OF THE INVENTION

The present invention relates to the field of insulation materials. The present invention relates in particular to a method of producing an acoustic and thermal insulation material. The invention also relates to an installation for implementing the method.

### DESCRIPTION OF THE PRIOR ART

Thermal and acoustic insulants have long been used in building, automotive, aeronautical, rail and naval construction. Often, these insulants are made of mineral wools or other products that may be harmful when handled and/or used or when they are destroyed. Increased awareness of these disadvantages has led manufacturers toward the production of insulation materials of natural origin. However, while these new insulants are neutral from an ecological standpoint they are not always entirely satisfactory in terms of their resistance to moisture, their resistance to heat and their longevity. There is an endless quest to produce insulants of natural origin and, more particularly, of plant origin, which are best able to meet the aforementioned requirements.

### SUMMARY OF THE INVENTION

It is a first object of the invention to provide a method of producing an insulation material. A second object of the invention is to provide a method of producing insulation material which minimizes the losses of raw material. It is a third object of the invention to provide a method of producing an insulation material that allows the dust generated during the production of the material to be recycled.

The method for producing an acoustic and thermal insulation material according to the invention comprises the following successive steps:
I. producing a mixture of fibers from a plurality of fiberous materials according to a predefined mixing recipe,
II. performing one or more treatments on the mixture of fibers in order to give said fiberous materials at least one characteristic,
III. stirring the mixture of fibers,
IV. conveying the mixture of fibers through a sorting device capable of removing non-fiberous residues that might be present in the mixture of fibers,
V. conveying the mixture of fibers through a mixing device capable of amalgamating the mixture of fibers with other, recycled, fibers,
VI. conveying the mixture of fibers through a metal detector device capable of detecting and of removing any metallic residues that might be present in the mixture of fibers,
VII. conveying the mixture of fibers through a lapping device capable of creating, from the mixture of fibers, a batt of fibers that has a top surface and a bottom surface,
VIII. then alternatively
a) conveying the batt of fibers through a heating and compacting device in order to create a finished fiber batt, or
b) first conveying the fiber batt through one or two needle looms in order to create a needled fiber batt, then conveying the needled fiber batt through a heating and compacting device in order to create a finished fiber batt, or
c) first adding to the bottom surface of the fiber batt a needled fiber batt that has been created beforehand, then conveying the assembled batts thus created through a heating and compacting device in order to create a finished fiber batt, or
d) first adding to the top surface of the fiber batt a needled fiber batt that has been created beforehand, then conveying the assembled fiber batts thus created through a heating and compacting device in order to create a finished fiber batt, or
e) first adding to the bottom surface and to the top surface of the fiber batt a respective needled fiber batt that has been created beforehand, then conveying the assembled fiber batts thus created through a heating and compacting device in order to create a finished fiber batt.

According to the invention, the production method may comprise, after one of steps a), b), c), d) or e), the additional step that consists in cutting the finished fiber batt to the desired dimensions as it leaves the heating device.

According to the invention, the production method may comprise, between step VII and step VIII, the additional step that consists in adding a web or a felt to one of the surfaces of the fiber batt.

According to the invention, the production method may comprise, after one of steps a), b), c) or d) or e), the additional step that consists in adding a web or a felt to one of the surfaces of the finished fiber batt as it leaves the heating device.

According to the invention, the production method may comprise an additional step that consists in recuperating the offcuts generated by the step that consists in cutting the finished fiber batt, grinding them up and reinjecting the fibers thus obtained into the mixing device.

The installation for implementing the method as described hereinabove comprises at least one weighing feeder, at least one opener, at least one lapping machine, at least one needle loom and at least one oven.

According to the invention, the installation may comprise first recuperation means able to recuperate the fine dust generated during implementation of said method and first conveying means able to convey this fine dust recuperated by the first recuperation means to conditioning means able to form this fine dust into briquettes.

According to the invention, the installation may comprise second recuperation means for recuperating the fine fibers generated during implementation of said method and second conveying means able to convey these fine fibers recuperated by the second recuperation means to the weighing feeder.

### BRIEF DESCRIPTION OF THE DRAWING

The invention will be better understood by those skilled the art from reading the following detailed description and from studying the accompanying drawing in which:

FIG. 1 is a block diagram of the production method according to the invention.

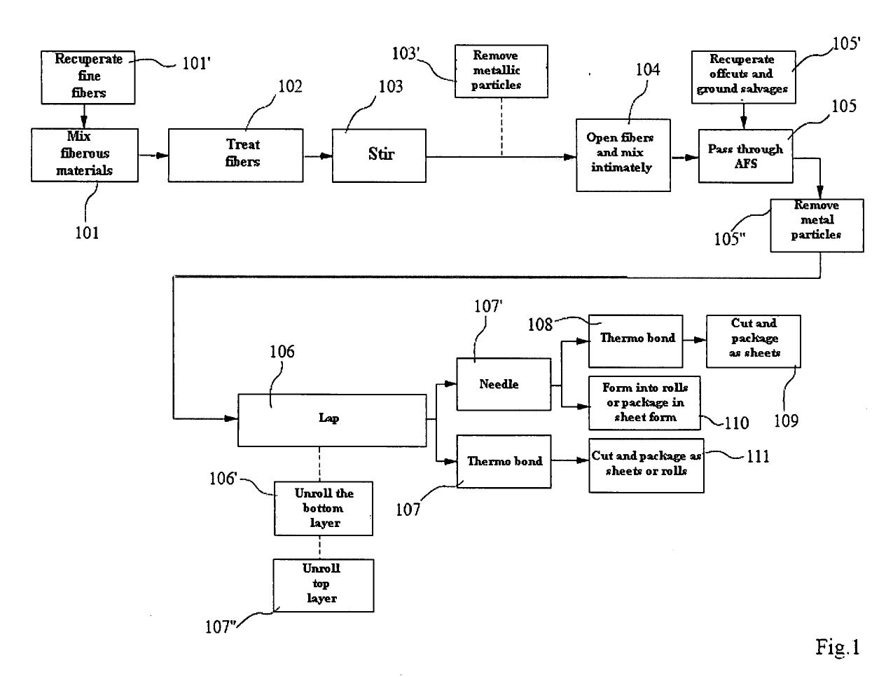

### DESCRIPTION OF THE PREFERRED EMBODIMENT

The first step 101 in the production method according to the invention is to produce a mixture of fibers from a plurality of fiberous materials using machines known as weighing feeders and to a predefined mixing recipe. These fiberous materials may be of plant origin (flax, cotton, etc.), animal origin (wools) or synthetic origin (polyester, polyamide, etc.). The quantity of each material is defined by a predefined mixing recipe which is recorded by the operator in a management system that manages the weighing feeders via a control workstation.

The production line preferably comprises a plurality of weighing feeder machines and each can weigh and feed a different fiber.

Creating the mixture of fibers first of all consists in placing bales (or bundles) of fiberous material on a conveyor belt of each of the weighing feeder machines. In addition, as will be described later on, the weighing feeders are also fed with fiberous material by second recuperation means on the production line which are able to recuperate and convey to the weighing feeders the fine fibers that are lost along the length of the production line. This step of feeding the weighing feeders with material recuperated from the production line is depicted in the FIGURE as an additional step 101′.

A conveyor belt then forwards the material to an inclined spiked belt that allows the material to be transported to weighing troughs. At the top of this inclined belt there is a cylinder, known as an evener roller, which rotates in an opposite direction to the forward movement of the inclined belt. The distance between the spikes of the belt and the spikes of this roller is adjustable and can be defined to suit the needs through the control workstation. Such adjustment in fact makes it possible for more or less opened material to be accepted into the trough. Next, in order to cause the material to drop into the weighing trough, a roller identical to the evener roller, but located near the trough and rotating in the direction of the inclined belt, detaches the material from the belt. A system for setting the weight for each of the weighing feeder machines, which weight is determined as a function of the mixing recipe, is also operated via the control workstation. When the required weight is reached, the inclined belt is stopped, and this stops the supply of fiberous material to the trough. The trough then opens onto a conveyor belt. On this conveyor belt, the mixture of fibers is therefore in a layered form.

The second step 102 of the method consists in performing one or more treatments on the mixture of fibers created during the previous step. These treatments are preferably carried out by spraying various chemical products onto the fibers, thus giving the fibers specific characteristics (antifungal, fire-resistance, anti-static, etc.).

The third step 103 of the production method according to the invention is then to transport the treated fibers into a machine known as a spiked opener which stirs the fibers in order to mix the fibers effectively in with the treatment products sprayed onto the fibers during the previous step. On leaving this machine, the fibers enter pipes in which if necessary they can undergo other types of treatment using a second spray-treatment system. This second treatment system may allow a further treatment to be carried out or may optimize the treatments carried out during the previous step.

During the next step 104 of the method, the treated fibers enter a reserve stack which allows the next machine to operate as far as possible continuously rather than batchwise. The next machine is a machine which is an opener, blender sorter able to open the fibers, stirring them once again, blend them and sort through the fibers in order to separate the fibers from any waste present. This machine will be known more simply as a “sorting device”. This sorting device has two opening sets. The first set consists of a trough, of a feed roller and of a spiked roller. The distance between the spiked roller and the trough allows the fiber to undergo greater or lesser degrees of “combing” and there is then a lower setting for more or less sorting materials that will be termed “non-fiberous residues” and which may consist of bits of straw, grains, etc. Using two sets optimizes the opening and allows the blending to be as intimate as possible. This yields a material which is more open, has better loft and is more individualized. This is in fact very important for certain types of fiber, for example when working sheep's wool, but also when the mixture of fibers contains synthetic binding fibers such as polyester for example. This is because the more open the fibers, the lower the percentage of binding fibers can be. Production costs incurred through the need for binding fibers can thus be appreciably limited.

Ahead of the abovementioned step it is possible to intersperse an additional step 103′ during which the fibers are carried into a magnet device, known as a magnetic chicane, which is able to remove from the fibers any metallic residues that might be present. Metallic particles indeed impair the insulating qualities of the material and it is thus possible to perform a first removal of these particles already at this point on the production line. However, this step is just one possible alternative which does not have to be set in place. Because of this, it is depicted in dotted line in the FIGURE.

The next step 105 is then to transport the mixture of fibers leaving the sorting device to a mixing device, more specifically to a system known as an air/fiber separator (ASF) which will not only recuperate the fibers leaving the sorting device but will also allow these fibers to be amalgamated with other fibers which are recycled along the production line, as will be described later on.

On leaving the AFS, the fibers are then transported through a metal detector device (step 105″) able to detect and remove all the fibers that may be contaminated with metallic particles. As has already been stated it is in fact important, in order to optimize the insulating nature of the insulation material, to remove as many as possible of the fibers that are contaminated with metallic particles.

In the next step 106, the material enters a lapping device. This lapping device more specifically comprises a machine known as a feeder-lapping machine or more simply a lapping machine. This machine makes it possible to create, from the mixture of fibers, a batt of fibers or fiber batt with a desired and constant weight across its entire width. To this end, the material arrives in a reserve stack, the material then passes between two vertical vibrating plates, which allows the weight to be completely homogenized across the entire width. This fiber batt thus formed arrives at a continuous weighing system which may work either using scales or using an X-ray system. The weighing system will accelerate or slow down the batt thus formed, according to the weight desired at output from this machine. This batt will then be transported on a spiked roller which will destructure this batt and scatter the fiber onto a perforated belt which progresses at the speed of the production line. Above this perforated belt there is a perforated roller subjected to suction. The addition of the perforated belt and of the perforated roller which travel at the same linear speed means that a fiber batt leaving the lapping machine is extremely uniform and at the required weight.

The weight of this batt may range between 400 g/m² and 8000 g/m² and its thickness may range from 20 mm to over 400 mm, according to requirements.

Ahead of this machine there is an unrolling system which, if necessary, allows a felt or a web or any other product that may be packaged in roll form to be added to the bottom surface of the fiber batt as it leaves the lapping machine. This web, felt or other may be attached to the fiber batt by mechanical binding (needling), by bonding or usually by thermobonding. Because, as will be explained later on, the fiber batt will then be transported through a heating device, or in other words through an oven, it is important for the felt or web added to the fiber batt at this point to be temperature-resistant. The web may therefore be a metal gauze, for example an aluminum gauze, a needled felt produced beforehand or may be made of any other temperature-resistant material.

The next part of the production method according to the invention depends on the product that is to be produced. Specifically, it is possible to produce several different types of insulation material based on the fiber batt created in the previous step.

A first type of finished product that can be produced is an insulation material known as an “un-needled monolayer” because it is made up of a single layer of fibers that does not pass through a needle loom. The method of producing this monolayer insulation material consists, in step 107, in transporting the fiber batt created in step 106 directly into a heating device, or in other words an oven. The oven thermally bonds the fibers of the fiber batt and this then is said to be a thermobonding step. The oven needed for the thermobonding step is a device in which the material, the fiber batt created during the previous step, passes between two height-adjustable perforated belts allowing a stream of hot air with a temperature of as much as 200° C. to pass. The characteristics of the air stream can be set to suit the requirements. Indeed it is possible to set the orientation of the stream, its flow rate and its temperature. After the heating zones of the oven there are cooling zones in which the bonding fibers harden. At the end of these zones, the finished fiber batt is, in a step 111, compacted then cut to the desired dimensions using mobile cutting devices which move according to the movement of the batt. The finished fiber batt can thus be cut into sheets or packaged as rolls.

In order to produce a second type of product, known as a “needled monolayer”, the production method according to the invention consists, during an additional step 107′, in transporting the fiber batt created during step 106 through one or two needle looms. The passage of the batt through a needle loom allows the batt to be needled on one of its surfaces. This has the effect of mechanically bonding the batt. In order to further increase the rigidity of the fiber batt, the fiber batt is transported directly from the exit of the first needle loom through a second needle loom, allowing the other surface of the fiber batt to be needled. Next, the finished fiber batt can be packaged directly into rolls or sheets (step 110). Alternatively, in order to produce a third type of product, known as a “thermobonded needled monolayer”, the batt, which has been needled on one surface or both surfaces, is transported into the oven during a step 108. On leaving the oven, the finished fiber batt thus created is then cut into sheets (step 109).

A fourth type of product which can be produced comprises a layer of fibers similar to the first type of product and a needled layer of fibers similar to the second type of product. It is then said to be a “bilayer” insulation material. To produce this type of product, use is made of a “needled monolayer” fiber batt already manufactured according to the method described hereinabove (second type of product) which is added as it leaves the lapping machine to the fiber batt created during step 106. To do this, a needled fiber batt is made available on an unwinding device and added, in step 106′, to the bottom surface of the fiber batt leaving the lapping machine. The finished fiber batt thus created is then transported into the oven then cut into sheets or formed into rolls.

Finally, in order to produce a fifth type of product, known as a “trilayer”, it is also possible to add to the top surface of the fiber batt (step 107″) created during step 106 a second layer consisting of a needled fiber batt already created according to the method described hereinabove (second type of product). The assembled fiber batts thus have, in the middle, an “un-needled monolayer” fiber batt and a “needled monolayer” fiber batt added to each of its surfaces. The assembled fiber batt thus created is then transported into the oven then the finished fiber batt is cut into sheets or formed into rolls.

It is also possible to interpose, after the exit from the oven and before the cutting step, a step which consists in adding, as it leaves the oven, a web or a felt of a material which is not able to withstand the temperature of the oven. This material is made available on an unwinding device positioned at the exit from the oven and is generally adhesively bonded. It is also possible at the oven exit to carry out various treatments which are able to confer certain characteristics upon the finished product, for example to make it impervious.

The installation used for implementing the methods described hereinabove therefore comprises at least one weighing feeder, at least one lapping machine, at least one needle loom and at least one oven. The installation also comprises first recuperating means and first conveying means which are able to recuperate and convey the fine dust generated along the entire length of the production line to a device which is able to form this fine dust into bricks or briquettes that can be used as fuel for wood burners. These means may comprise suction devices, sorting devices, various tubes or pipes, compacting means, etc. These first recuperating and conveying means are therefore able to recycle the fine dust generated along the entire production line into a fuel material. These means thus not only prevent this fine dust from being deposited on the production line and impeding the production of the insulation material, but also allow this dust to be recycled. They thus offer the operator an additional economic advantage through the sale and distribution of fuel materials for wood burners.

As was stated earlier, the installation further comprises second recuperation means able to suck up the fine fibers lost along the entire length of the production line and convey them to the weighing feeders. These means thus allow the fine fibers lost along the entire length of the production line to be recycled so that they can be put back into the manufacturing circuit. These means thus allow effective and continuous recycling of valuable materials and thus limit the need for raw materials.

Finally, the installation comprises third recuperation means which are able to recuperate the offcuts and selvedges generated during the cutting steps. These means comprise devices capable of grinding the offcuts into fibers and of conveying the fibers to the mixing device (AFS) so that they too can be returned to the manufacturing circuit. The step consisting of the recuperation of the offcuts and selvedges is depicted in the FIGURE as an additional step 105′. These means therefore allow a further limitation on losses of raw material in the production process.

What is claimed is:

1. A method for producing an acoustic and thermal insulation material comprising the following successive steps:
I. producing a mixture of fibers from a plurality of fiberous materials according to a predefined mixing recipe,
II. performing one or more treatments on the mixture of fibers in order to give said fiberous materials at least one characteristic,
III. stirring the mixture of fibers,
IV. conveying the mixture of fibers through a sorting device capable of removing non-fiberous residues that might be present in the mixture of fibers,
V. conveying the mixture of fibers through a mixing device capable of amalgamating the mixture of fibers with other, recycled, fibers,
VI. conveying the mixture of fibers through a metal detector device capable of detecting and of removing any metallic residues that might be present in the mixture of fibers,
VII. conveying the mixture of fibers through a lapping device capable of creating, from the mixture of fibers, a batt of fibers that has a top surface and a bottom surface,
VIII. then alternatively
a) conveying the batt of fibers through a heating and compacting device in order to create a finished fiber batt, or
b) first conveying the fiber batt through one or two needle looms in order to create a needled fiber batt, then conveying the needled fiber batt through a heating and compacting device in order to create a finished fiber batt, or
c) first adding to the bottom surface of the fiber batt a needled fiber batt that has been created beforehand, then conveying the assembled batts thus created through a heating and compacting device in order to create a finished fiber batt, or
d) first adding to the top surface of the fiber batt a needled fiber batt that has been created beforehand, then conveying the assembled fiber batts thus created through a heating and compacting device in order to create a finished fiber batt, or
e) first adding to the bottom surface and to the top surface of the fiber batt a respective needled fiber batt that has been created beforehand, then conveying the assembled fiber batts thus created through a heating and compacting device in order to create a finished fiber batt.

2. The production method as claimed in claim 1 and which also comprises, after one of steps a), b), c), d) or e), the additional step that consists in cutting the finished fiber batt to the desired dimensions as it leaves the heating device.

3. The production method as claimed in claim 1 and which also comprises, between step VII and step VIII, the additional step that consists in adding a web or a felt to one of the surfaces of the fiber batt.

4. The production method as claimed in claim 1 and which also comprises, after one of steps a), b), c) or d) or e), the additional step that consists in adding a web or a felt to one of the surfaces of the finished fiber batt as it leaves the heating device.

5. The production method as claimed in claim 2, and which also comprises an additional step that consists in recuperating the offcuts generated by the step that consists in cutting the finished fiber batt, grinding them up and reinjecting the fibers thus obtained into the mixing device.

6. An installation for implementing the method as claimed in claim 1, said installation comprising at least one weighing feeder, at least one opener, at least one lapping machine, at least one needle loom and at least one oven.

7. The installation as claimed in claim 6, and which also comprises first recuperation means able to recuperate the fine dust generated during implementation of said method and first conveying means able to convey this fine dust recuperated by the first recuperation means to conditioning means able to form this fine dust into briquettes.

8. The installation as claimed in claim 6, and which also comprises second recuperation means for recuperating the fine fibers generated during implementation of said method and second conveying means able to convey these fine fibers recuperated by the second recuperation means to the weighing feeder.
